(19) United States
(12) Patent Application Publication
(10) Pub. No.: US 2025/0257712 A1
(43) Pub. Date: Aug. 14, 2025

(54) TUBULAR TURBINE SYSTEMS AND METHODS

(71) Applicant: Alternative Sustainability IP LLC, Fleming Island, FL (US)

(72) Inventor: John A. STEVENS, New York, NY (US)

(73) Assignee: Alternative Sustainability IP LLC, Fleming Island, FL (US)

(21) Appl. No.: 18/436,951

(22) Filed: Feb. 8, 2024

(51) Int. Cl. F03D 1/04; F03D 1/02; F03D 9/25

(52) U.S. Cl. CPC F03D 1/04; F03D 1/025; F03D 9/25; F05B 2220/20; F05B 2220/7068; F05B 2280/105; F05B 2280/1071; F05B 2280/4003

(57) ABSTRACT

A turbine system configured to convert fluid energy into electrical power is disclosed. The turbine system includes a tubular frame, a shaft disposed in the tubular frame, a fan coupled to the shaft, and at least one turbine that utilizes rotation of adjacent copper coil discs and magnetic discs to generates energy when a fluid impinges the fan. This configuration allows for a smaller turbine system that may be placed in various compact spaces and that provides a localized, efficient source of electrical energy

### TECHNICAL FIELD

The present disclosure relates generally to a turbine system and related methods.

### BACKGROUND

Energy generation from renewable sources is becoming increasingly important due to environmental concerns and the need for sustainable power generation. Buildings account for 40% of all CO2 emissions around the world. A common method to reduce CO2 emissions is by reducing electricity use and producing clean energy in order to lower carbon footprint. Turbines are commonly used to harness energy, including wind or solar turbines. However, these turbines may be expensive to build and maintain, may have limited efficacy, and are ultimately not sustainable. Thus, there is a need for a smaller turbine system that may be placed in various compact spaces and that provides a localized, efficient source of electrical energy.

### SUMMARY

An embodiment of the present disclosure includes a system a tubular frame having an internal space. The system further includes a shaft in the tubular frame. The system further includes a fan coupled to the shaft and configured to rotate the shaft when a fluid impinges the fan. The system further includes at least one turbine coupled to the shaft and housed in the internal space of the tubular frame. The at least one turbine has a copper containing disc including a plurality of copper coils mounted in the copper containing disc. The at least one turbine further includes an electronics board electronically coupled to the copper coils in the copper containing disc. The at least one turbine further includes a magnet containing disc mounted on the shaft and arranged adjacent to the copper containing disc. The copper containing disc has a plurality of magnets mounted in the magnet containing disc. The magnet containing disc is configured to rotate with the shaft in response to fluid impinging on the fan. The turbine is configured to generate energy in response rotation of the magnet containing disc.

Another embodiment of the present disclosure includes a method. The method includes positioning at least one tubular turbine in a shaft of an HVAC or airway system in a building. The method further includes causing air flow to impinge a fan of the at least one turbine. The method further includes, in response to air flow impinging the fan, causing a set of magnet containing discs to rotate relative to a set of copper containing discs.

### BRIEF DESCRIPTION OF THE DRAWINGS

The foregoing summary, as well as the following detailed description of exemplary embodiments of the present application, are better understood when read in conjunction with the appended drawings. For the purposes of illustrating the present application, there is shown in the drawings, exemplary embodiments of the disclosure. It should be understood, however, that the application is not limited to the precise arrangements and instrumentalities shown. In the drawings:

FIG. 1 is a top view of a turbine system in accordance with an exemplary embodiment of the present disclosure;

FIG. 2 is a front view of the turbine system shown in FIG. 1;

FIG. 3 is a back view of the turbine system shown in FIGS. 1-2;

FIG. 4 is a side view of the turbine system shown in FIGS. 1-3;

FIG. 5 is a perspective side view of the turbine system shown in FIGS. 1-4;

FIG. 6 is a side view of the turbine system shown in FIGS. 1-5 with the front plate and casings removed;

FIG. 7A is a top view of the turbine system shown in FIGS. 1-6 with the moveable panel removed;

FIG. 7B is a cross-sectional diagram of the turbine system shown in FIGS. 1-6;

FIG. 8 is a top view of a magnet disc of the turbine shown in FIGS. 1-7;

FIG. 9 is top view of a copper disc of the turbine shown in FIGS. 1-7;

FIG. 10 is a side view of an enclosure of the turbine system in accordance with an embodiment of the present disclosure;

FIG. 11 is a side view of an enclosure of the turbine system in accordance with an embodiment of the present disclosure;

FIG. 12 is a perspective view of the turbine system shown in FIGS. 1-9 having a stacked turbine configuration in accordance with an embodiment of the present disclosure;

FIG. 13 is a side view of the turbine system shown in FIG. 12;

FIG. 14 is a side view of the turbine system shown in FIGS. 1-9 having a stacked turbine configuration in series in accordance with an embodiment of the present disclosure;

FIG. 15 is a perspective view of the turbine system shown in FIGS. 1-9 having an end to end configuration in accordance with an embodiment of the present disclosure;

FIG. 16 is a perspective view of the turbine system in an HVAC system, with side and front parts of the HVAC system cut away, in accordance with an embodiment of the present disclosure; and

FIG. 17 is a side view of the turbine system shown in FIG. 15, with the front part of the HVAC system cut away.

### DETAILED DESCRIPTION OF ILLUSTRATIVE EMBODIMENTS

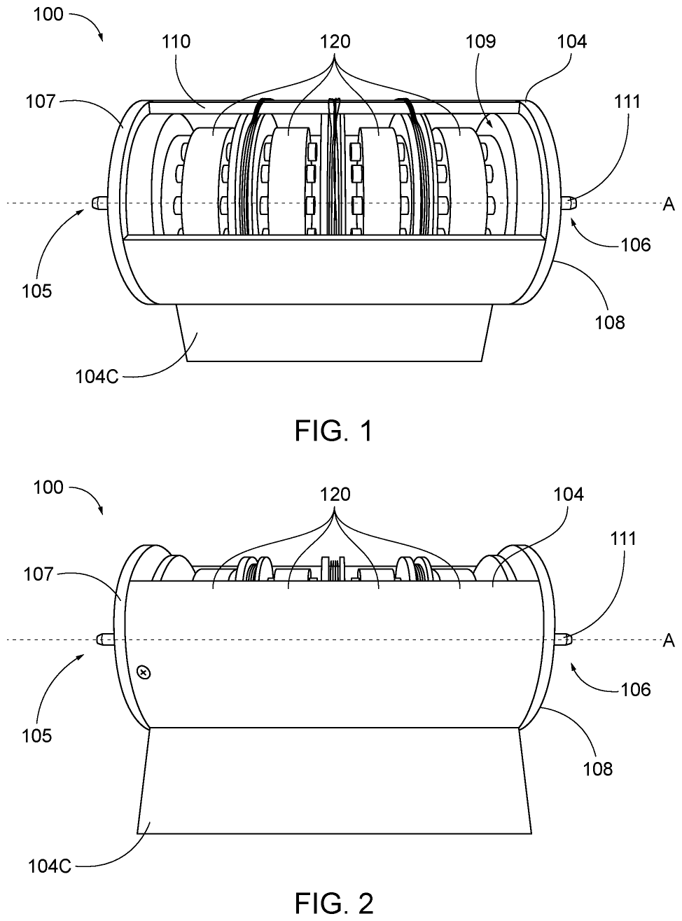

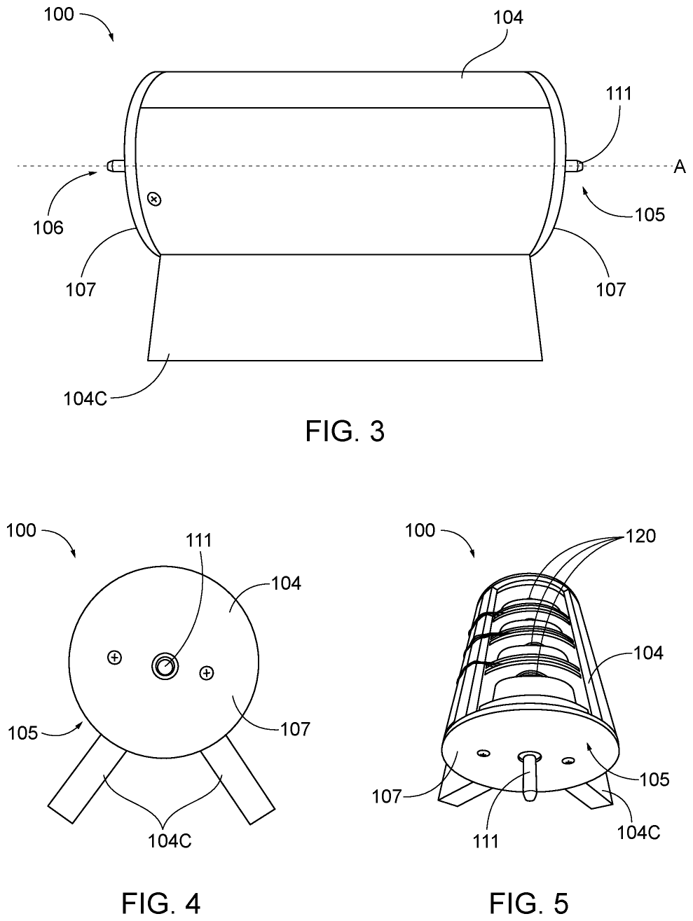

Turbine systems as described are configured for converting fluid energy into electrical power. Referring to FIGS. 1-6, there is shown an exemplary embodiment of a turbine system 100. The turbine system 100 comprises various components configured to harness and transform fluid energy into a usable electrical form. The turbine system 100 may be utilized in an HVAC system. In alternative embodiments, the turbine system 100 may be utilized in circulating fan frames and other applications including, but not limited to, power generation. The turbine system 100 includes a tubular frame 104, a shaft disposed in the tubular frame 111, a fan 116 coupled to the shaft 111, and at least one turbine 120 that generates energy in response to a fluid impinging the fan 116. A fluid generally means an air; however, other fluids could be used. For instance, the system 100 is generally designed to be inserted in the ductwork and HVAC systems in existing or new buildings. Thus air flow through these systems, when the system 100 is installed, can be used to generate power. The system 100 may also be used in exhaust lines of such systems so that exit flow rotates the fan to generate power, thereby reclaiming energy used to operate the HVAC system.

The tubular frame 104 serves as the structural backbone for housing and supporting components of the turbine system 100. The tubular frame includes an upper casing 104A, a main casing 104B, and a lower casing 104C. The main casing 104B includes a first end 105 and a second end 106 opposite the first end 105 along a longitudinal axis A. The main casing 104B further includes a removable first plate 107 disposed at the first end 105 and a removable second plate 108 disposed at the second end 106. The main casing 104B defines an internal space 109 that accommodates various components of the system 100. It should be noted that the main casing 104B is not limited to specific dimensions, but in various embodiments, the main casing 104B is cylindrical and possesses a diameter of at least 9 inches and a length of at least 14 inches. The lower casing 104C extends from the main casing 104B and is configured to mount the tubular frame 104 to a surface, such as a ductwork or HVAC system surface. The tubular frame 104 may be constructed from a polymer material to provide structural integrity and lightweight properties. In alternative embodiments, the tubular frame 104 may be made from other known materials, such as metals, alloys, and the like.

Thee tubular frame 104 includes a movable panel 110 located at a top portion of the main casing 104B. This construction allows the panel 110 to pivot about the shaft 111. The ability of the panel 110 to open allows easy access to the system components for maintenance and inspection purposes.

The shaft 111 is configured to serve as a rotational axis for the turbine system 100. As shown, the shaft 111 is disposed within the internal space 109 of the tubular frame 104 and extends through the first end 105 and the second end 106 along the longitudinal axis A. The shaft 111 includes a forward end 110 at the first end 105 and a rearward end 112 at the second end 106. The shaft 111 may have as a diameter of preferably about 8.0 mm. The shaft 111 may have a length of preferably about 16.0 inches. A set of bearings 113 may be disposed on the shaft 108 and movably coupled to the first plate 107 and the second plate 108.

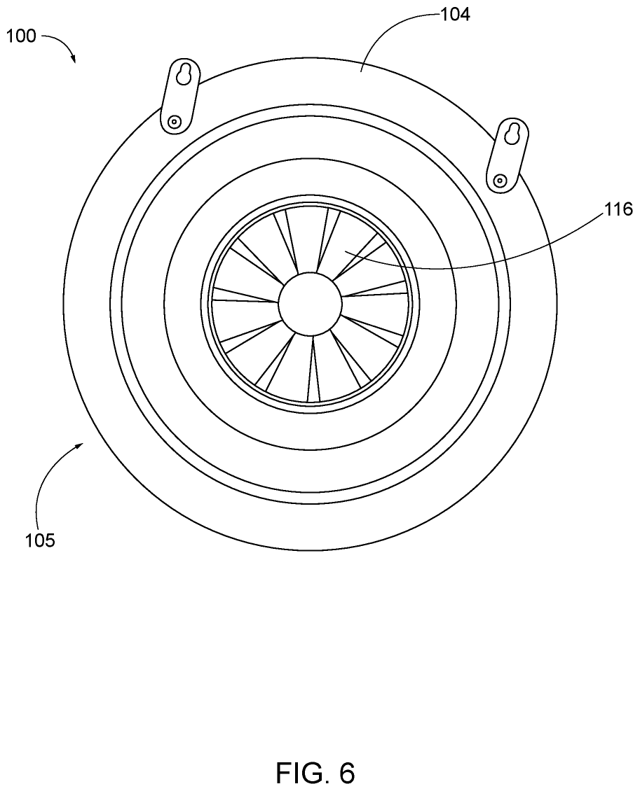

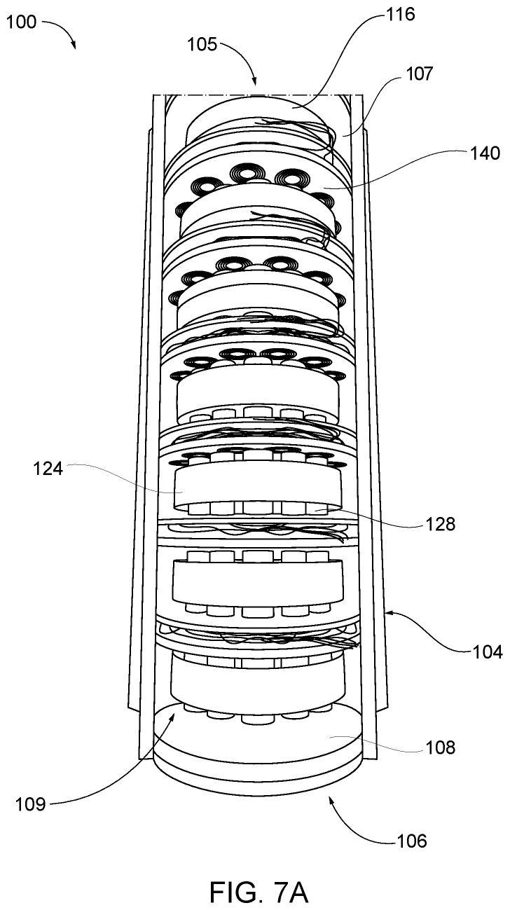

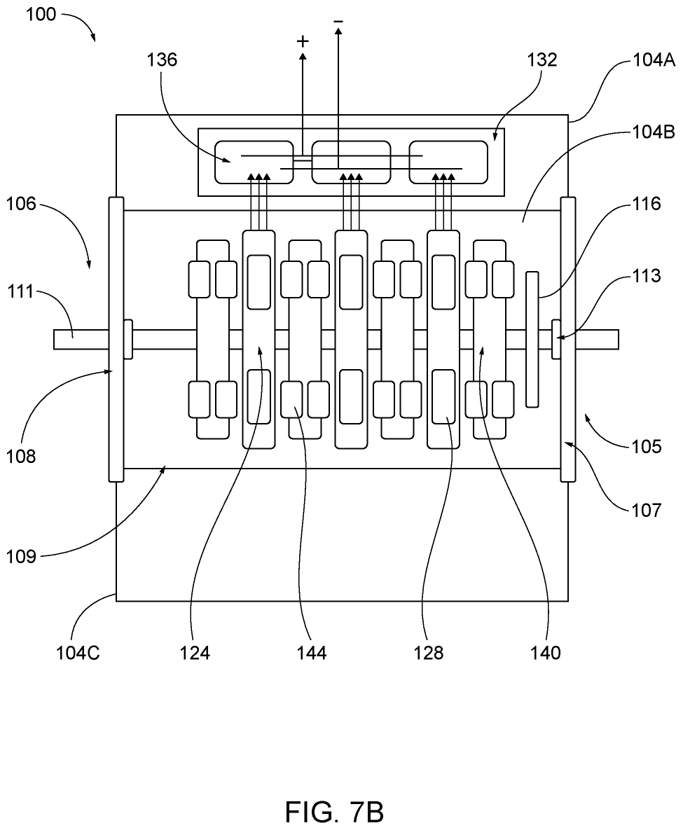

Referring to FIGS. 6 and 7, the fan 116 is fixed to the shaft 111. The fan 116 is uniquely configured to rotate the shaft 111 when exposed to fluid flow, such as air impinging on the fan 116. As the fan 116 rotates, it imparts motion to the shaft 111, thereby initiating the energy conversion process from fluid energy into electrical energy. Specifically, as fluid impinges the fan 116, the fan 116 rotates the shaft 111. This rotation, as explained in further detail below, generates an electric field that is harnessed by the turbine 120 for use as needed. This configuration allows the shaft 111 to withstand the rigors of continuous rotation, ensuring durability and resistance of the tubular turbine 100.

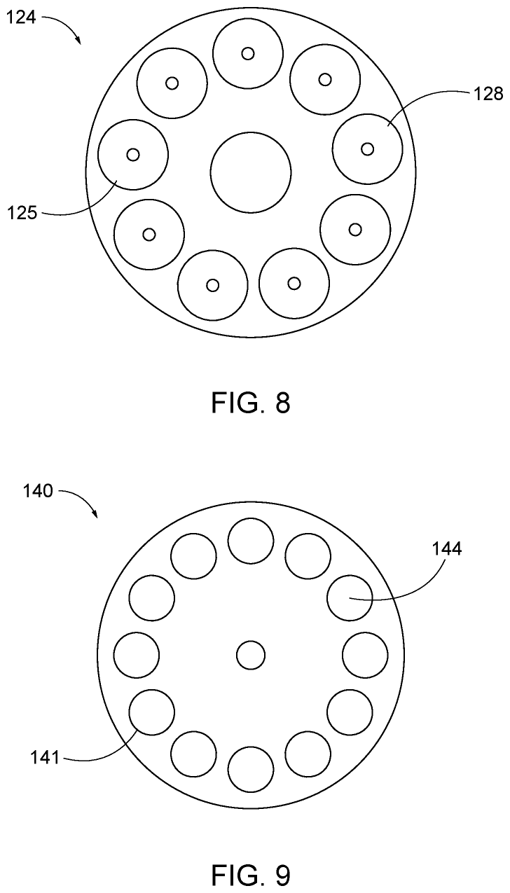

Referring to FIGS. 7 and 8, the turbine 120 is configured to enable energy generation using a combination of copper containing discs 124 and magnet containing discs 140. This configuration maximizes efficiency and power output. The copper containing discs 124 are cylindrical bodies with a thickness that is substantially less than their respective diameter. Each disc 124 may have a diameter between 3 inches and 6 inches, preferably at least 4 inches. The discs 112 include multiple through-holes or recesses 125, which contain a plurality of circular copper coils 128, respectively. In alternative embodiments, the diameter of the copper-containing discs 124 and the number of copper coils 128 in each disc vary. In one example the turbine 120 includes at least three copper-containing discs 124. In another example, the turbine 120 may include fewer than three copper-containing discs 124. In another example, the turbine 120 may include a maximum of 8 copper containing discs 124 and 10 magnet containing discs 140.

The copper coils 128 are used in generation of electrical energy within the system. The copper coils 128 are circular in cross-sectional shape and are mounted within the copper-containing discs 124 within the recesses. In the illustrated embodiment, nine separate copper coils 128 are incorporated into each disc 124. In one embodiment, each disc 124 includes 24-gauge wire coils. In another embodiment, each disc 124 includes 23-gauge wire coils.

The turbine 120 further includes an electronics board 132 that may be used to carry various electronic components. As shown, the electronics board is contained in the upper casing 104A of the tubular frame 104. However the electronics board could be located in other areas of the system 100 as needed. The electronics board 132 is electronically coupled to the copper coils 128. The electronics board 132 includes two or more rectifiers 136 configured to convert alternating current generated by the copper coils 128, via rotation of the shaft, into direct current. The rectifiers 136 thus make the energy output compatible with various applications. In the illustrated embodiment, the electronics board 132 includes three rectifiers, each of which are electronically coupled to individual copper-containing discs 124. In the illustrated embodiment, the electronics board 132 is in the form of a circuit board.

Continuing with FIGS. 7-9, the turbine 120 further includes a plurality of magnet-containing discs 140. The magnet containing discs 140 have a cylindrical body with a plurality of through-holes or recesses 141 within which magnets are mounted. Each disc 140 has a diameter of at least 3.5 inches and a width of at least 0.625 inches. In alternative embodiments, the diameter of the magnet-containing discs 140 and the number of magnets in each disc vary. In the illustrated embodiment, the turbine 120 includes between three and eight magnet containing discs, preferably at least four magnet-containing discs 140. In alternative embodiments, the turbine 120 may include fewer than four magnet-containing discs 140. The magnet-containing discs 140 are coaxially mounted to the shaft 111. The magnet-containing discs 140 are further disposed on either side of the copper-containing discs 124 such that the copper-containing discs 124 and the magnet-containing discs 140 alternate in series along the shaft 111 in the turbine 120.

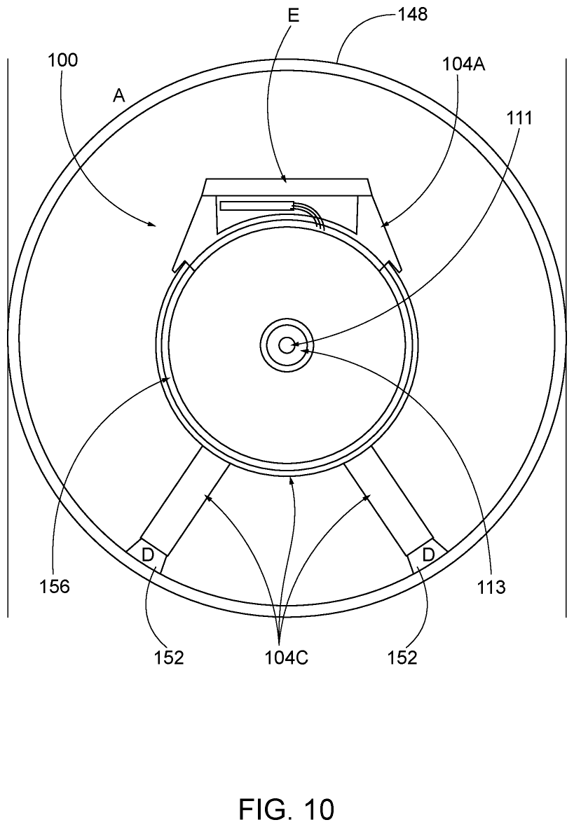

Referring to FIG. 9, each of the plurality of magnet-containing discs 140 is equipped with a plurality of circular magnets 144. In the illustrated embodiment, twelve round magnets are incorporated into each disc 140. The magnets 144 are positioned relative to the copper coils so that rotation of the copper containing discs 124 relative to the magnet containing discs 140 creates a relative velocity between the copper coils 128 of the copper containing discs 124 and the magnets 144 of the magnet containing discs 140. Due to this relative velocity, a circulating current is induced inside the copper containing discs 124, inducing electrical generation as the magnets 144 pass by the copper coils 128. In this configuration, the turbine 120 has a relative velocity of approximately 25 miles per hour and generates approximately 120 watts.

As fluid impinges on the fan 116, causing it to rotate the shaft 111, the magnet-containing disc 140 rotates relative to the copper-containing disc 124. This rotational generates energy within the system 100. Specifically, rotation of the copper coils 128 of the copper containing discs 124 relative to the magnets 144 of the magnet containing disc 140 generates an electric field in the copper coils 128, which causes an electrical current to flow through the coil wires. In one embodiment, the turbine 100 produces a specific voltage, such as 16 volts per copper-containing disc at a shaft speed of 1,700 rpm. In another embodiment, the turbine 100 produces 380 volts per copper-containing disc at a shaft speed of 2,800 rpm. The energy generated is then made available for various applications, including, but not limited to, power generation, HVAC systems, and circulating fan frames.

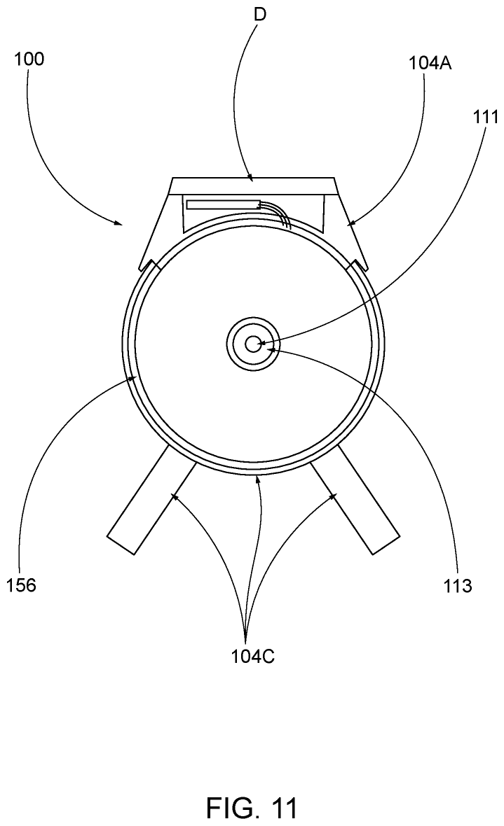

Referring to FIGS. 10 and 11, the system 100 may be configured to fit an enclosure used for turbine slide frames as described in U.S. Pat. No. 11,371,103, the entire contents of which are incorporated herein. In this configuration, the system 100 may be enclosed in an outer shell 148. The outer shell 148 may be an air tube comprised of PVC. In the illustrated embodiment, the diameter of the outer shell 148 may be 9 inches. In alternative embodiments, the diameter of the outer shell 148 is less than 9 inches. The system 100 may be mounted at the lower casing 104C via one or more casing mounts 152. The system 100 further includes a wiring compartment cover 156 configured to surround the shaft 111.

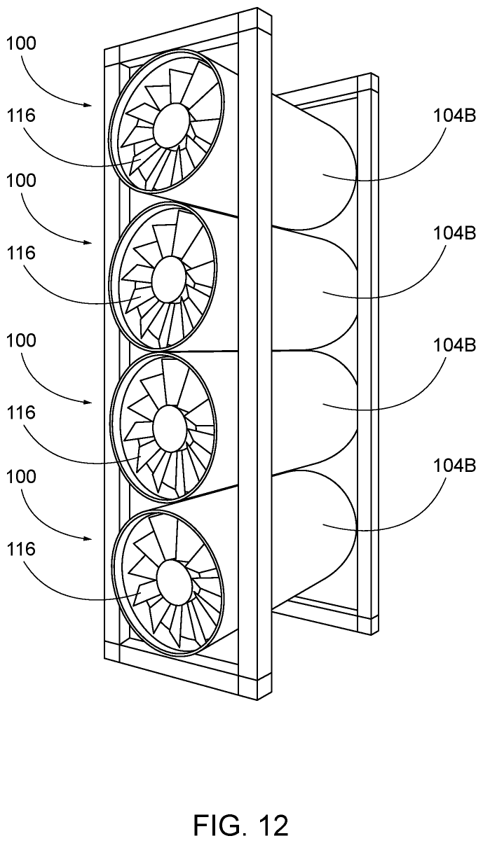

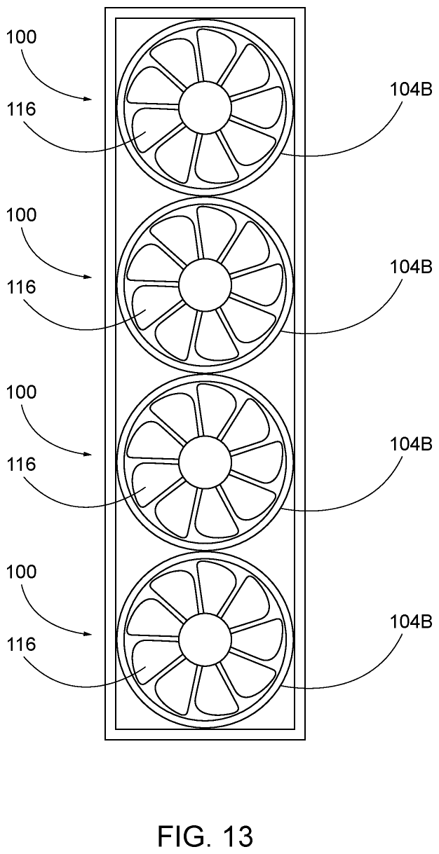

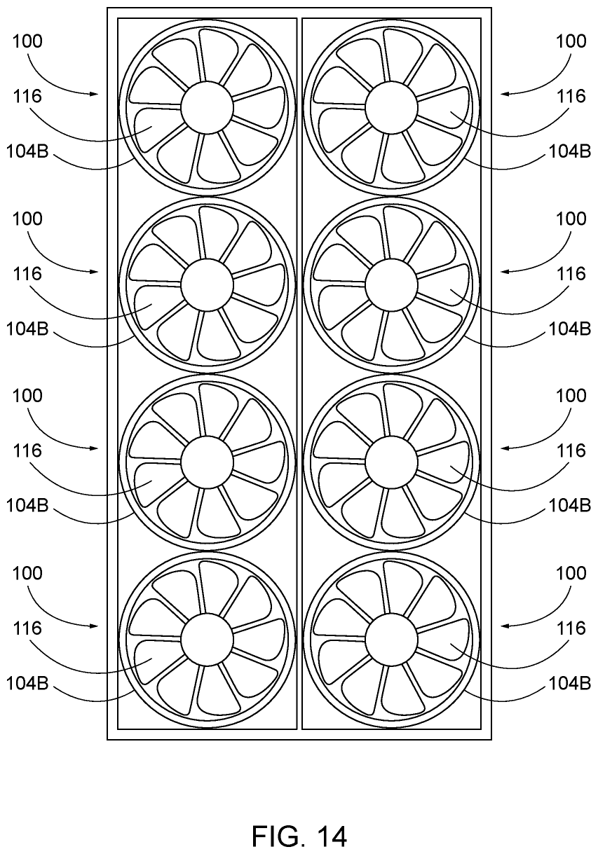

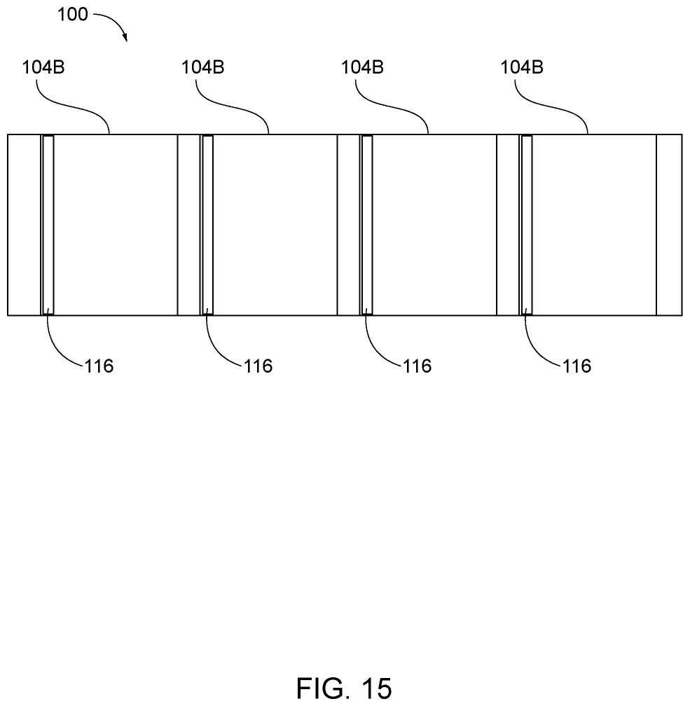

Referring to FIGS. 12-14, the system 100 can be configured as a set of turbines arranged in a stacked configuration. Referring to FIG. 15, in an alternative embodiment, the system 100 can be configured as a series of turbines connected end-to-end to accommodate varying operational requirements and energy generation capacities.

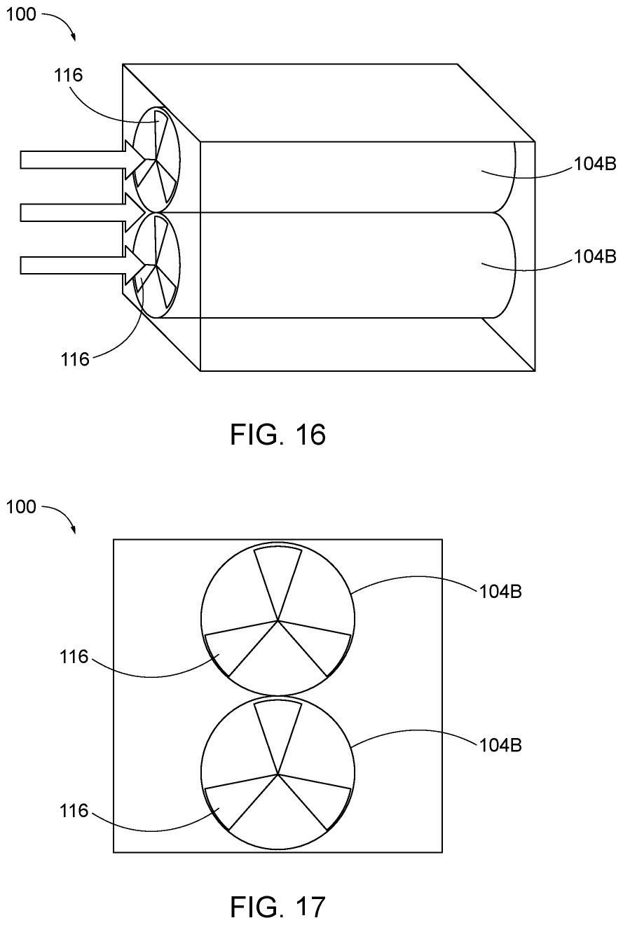

Referring to FIGS. 16-17, a further embodiment of the present disclosure includes a method generating energy in an HVAC system. The method includes placing a turbine system 100 in ductwork of the HVAC system. At least one tubular turbine system 100 is positioned in the shaft of an HVAC or airway system in a building. The fan 116 is then impinged by air flow. In response to air flow impinging the fan 116, a set of magnet-containing discs 140 is configured to rotate relative to the set of copper-containing discs 124.

Wherever possible, the same or like reference numbers are used throughout the drawings to refer to the same or like features. It should be noted that the drawings are in simplified schematic form and are not drawn to precise scale. Certain terminology used in the description is for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the present disclosure in any manner not explicitly set forth. Additionally, the term “a,” as used in the specification, means “at least one.” The terminology includes the words above specifically mentioned, derivatives thereof, and words of similar import.

“Substantially” as used herein shall mean considerable in extent, largely but not wholly that which is specified, or an appropriate variation therefrom as is acceptable within the field of art. “Exemplary” as used herein shall mean serving as an example.

Furthermore, the described features, advantages and characteristics of exemplary embodiments may be combined in any suitable manner in one or more embodiments. One skilled in the art will recognize, in light of the description herein, that the exemplary embodiments can be practiced without one or more of the specific features or advantages of a particular embodiment. In other instances, additional features and advantages may be recognized in certain embodiments that may not be present in all embodiments of the present disclosure.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in an order as desired.

1. A system comprising:
a tubular frame having an internal space;
a shaft in the tubular frame;
a fan coupled to the shaft and configured to rotate the shaft when a fluid impinges the fan;
at least one turbine coupled to the shaft and housed in the internal space of the tubular frame, the at least one turbine having:
a copper containing disc including a plurality of copper coils mounted in the copper containing disc;
an electronics board electronically coupled to the copper coils in the copper containing disc;
a magnet containing disc mounted on the shaft and arranged adjacent to the copper containing disc, the copper containing disc having a plurality of magnets mounted in the magnet containing disc, the magnet containing disc being configured to rotate with the shaft in response to fluid impinging on the fan;
wherein the turbine is configured to generate energy in response rotation of the magnet containing disc.

2. The system according to claim 1, wherein the at least one turbine has three copper containing discs and four magnet containing discs.

3. The system according to claim 1, wherein the at least one turbine has a mounting for attachment to the frame.

4. The system according to claim 1, wherein the tubular frame has a diameter of at least 9 inches.

5. The system according to claim 1, wherein the tubular frame has a length of at least 14 inches.

6. The system according to claim 1, wherein the tubular frame is formed from a polymer material.

7. The system according to claim 1, wherein the electronics board includes two or more rectifiers coupled to at least one of the copper containing disc.

8. The system of claim 7, wherein the mounting board is a circuit board.

9. The system of claim 1, wherein copper coils are circular in cross-sectional shape.

10. The system of claim 1, wherein copper containing disc includes nine separate copper coils.

11. The system of claim 1, wherein the copper containing disc has a diameter of at least 4 inches.

12. The system of claim 1, wherein the magnet containing disc include twelve round magnets.

13. The system of claim 1, wherein the magnet containing disc has a diameter of at least 3.5 inches.

14. The system of claim 13, wherein the shaft is a stainless-steel shaft.

15. The system of claim 1, wherein the turbine produces 16 volts per copper containing? disc at a shaft? speed of 1,700 rpm.

16. The system of claim 1, wherein the turbine produces 380 volts at a shaft speed of 2,800 rpm.

17. The system of claim 1, wherein the tubular frame is configured to be placed in an outer frame.

18. The system of claim 17, wherein the outer frame includes HVAC ductwork.

19. The system of claim 17, wherein the outer frame includes a circulating fan frame.

20. The system of claim 1, wherein the tubular frame has a movable panel that when opened exposes the components of the turbine.

21. The system of claim 1, wherein the at least one turbine is a series of turbines connected end-to-end.

22. The system of claim 1, wherein the at least one turbine is a set of turbines arranged in a stacked configuration.

23. A method, comprising:
positioning at least one tubular turbine in a shaft of an HVAC or airway system in a building;
causing air flow to impinge a fan of the at least one turbine;
in response to air flow impinging the fan, causing a set of magnet containing discs to rotate relative to a set of copper containing discs.
